(19) United States
(12) Patent Application Publication
(10) Pub. No.: US 2012/0163017 A1
(43) Pub. Date: Jun. 28, 2012

(54) ELECTRONIC DEVICE WITH LIGHT GUIDING PIPE

(75) Inventor: ZHI-HUA LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/206,709

(22) Filed: Aug. 10, 2011

(30) Foreign Application Priority Data
Dec. 25, 2010 (CN) 201010606858.4

(51) Int. Cl. G02B 6/00

(52) U.S. Cl. 362/581

(57) ABSTRACT

An electronic device includes a housing, an adhering member, and a light guiding pipe. The housing includes a side wall defining a stepped fixing hole, the stepped fixing hole includes a fixing surface towards the inside of the housing. The light guiding pipe includes a light guiding portion. The light guiding portion includes a main body and a flange formed at the outer side of the main body. The flange includes an assembly surface corresponding to the fixing surface. The light guiding pipe is adhered to the housing by the adhering member, with the light guiding pipe inserted in the stepped fixing hole and the assembly surface resisting against the fixing surface.

### BACKGROUND

1. Technical Field

The present disclosure relates to electronic devices, particularly to an electronic device with a light guiding pipe.

2. Description of Related Art

Many electronic devices include a housing and a light guiding pipe. The housing defines a through hole. The light guiding pipe includes a main body and a fixing portion connecting with the main body. An end of the main body is inserted into the through hole of the housing with the fixing portion adhered to the inner surface of the housing.

However, it is difficult to control the machining precision of the inner surface and the thickness of the housing by CNC machine manufacturing due to the effects of the process orientation and the strength of the milling cutter. This may affect the outer appearance of the electronic devices.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the electronic device. Moreover, in the drawings like reference numerals designate corresponding parts throughout the several views. Wherever possible, the same reference numerals are used throughout the drawings to refer to the same or like elements of an embodiment.

FIG. 1 is an isometric view of an embodiment of a part of an electronic device; the electronic device includes a light guiding pipe.

FIG. 2 is an exploded, isometric view of the electronic device of FIG. 1.

FIG. 3 is similar to FIG. 2, but viewed from another aspect.

FIG. 4 is an enlarged, isometric view of the light guiding pipe of the electronic device of FIG. 1.

FIG. 5 is similar to FIG. 4, but viewed from another aspect.

FIG. 6 is a partial, enlarged, cross-sectional view of the electronic device of FIG. 1, taken along line VI-VI.

### DETAILED DESCRIPTION

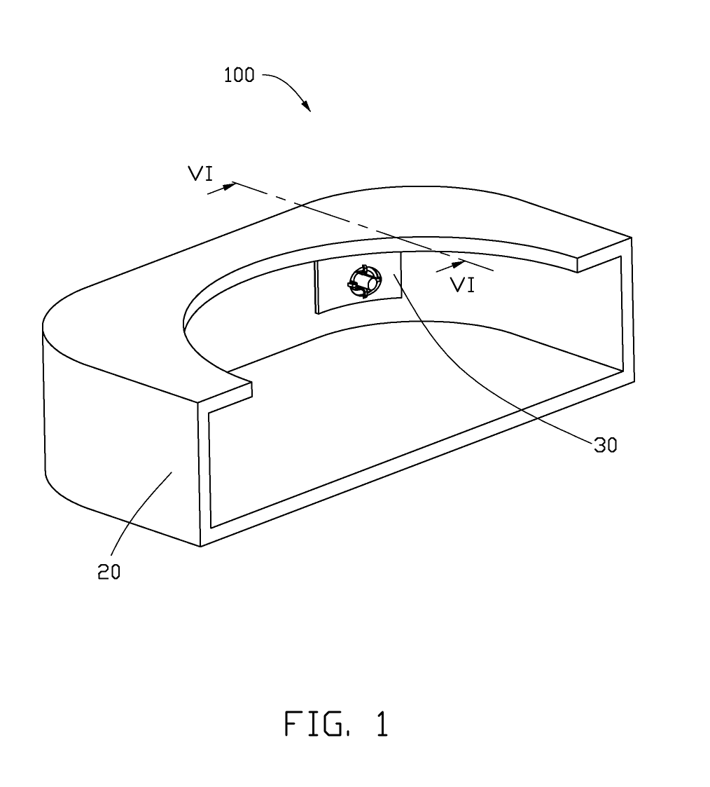

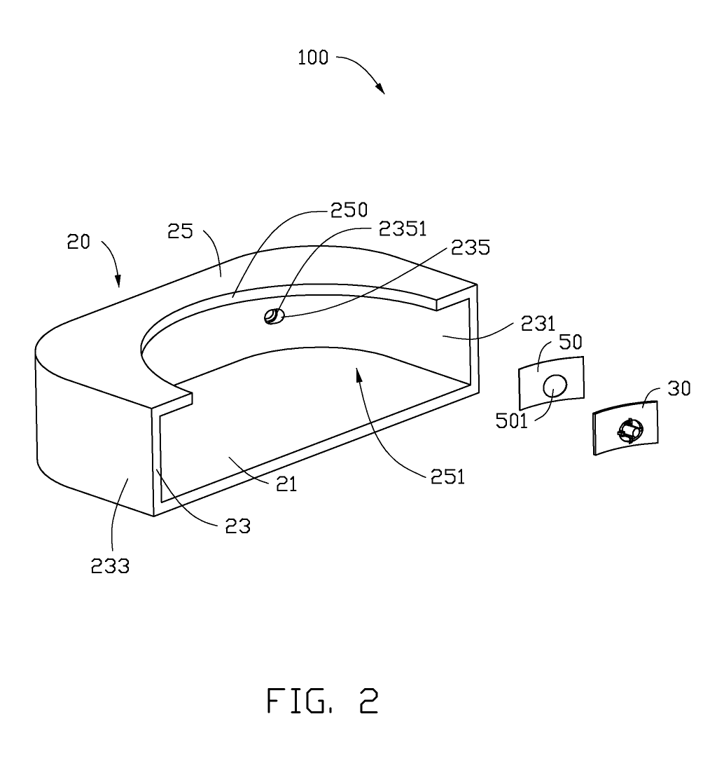

Referring to FIG. 1 and FIG. 2, an embodiment of an electronic device 100 includes a housing 20, a light guiding pipe 30, and an adhering member 50. The light guiding pipe 30 is adhered to the housing 20 by the adhering member 50. The electronic device 100 may be a notebook computer, a desktop computer, a liquid crystal display, or other electronic devices. In the illustrated embodiment, the electronic device 100 is a desktop computer.

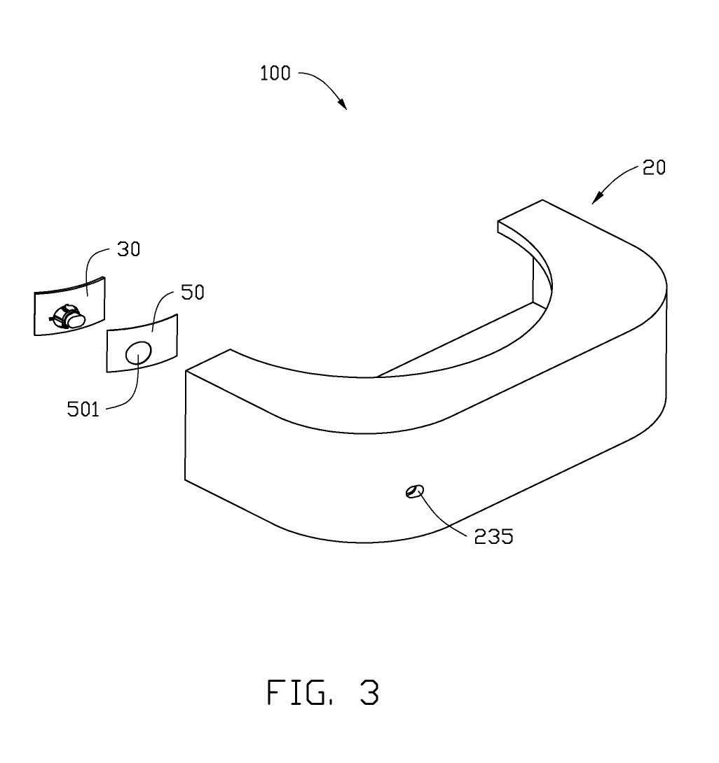

Referring to FIG. 3, the housing 20 can be substantially square shaped. The housing 20 includes a bottom cover 21, a side wall 23 extending upward from an edge of the bottom cover 21, and a top cover 25 extending from an end of the side wall 23 away from the bottom cover 21. In the illustrated embodiment, the bottom cover 21 can be a substantially flat board and the side wall 23 can be substantially arc-shaped. The top cover 25 is substantially parallel to the bottom cover 21. The top cover 25 defines an opening 250 in the center. The bottom cover 21, the side wall 23, and the top cover 25 cooperatively define a receiving space 251 with the opening 250 receiving the light guiding pipe 30 and other electronic components (not shown). The side wall 23 includes an inner surface 231 and an outer surface 233 opposite to the inner surface 231. The outer surface 233 defines a stepped fixing hole 235. The stepped fixing hole 235 includes a fixing surface 2351 (see FIG. 2) towards the inside of the housing 20.

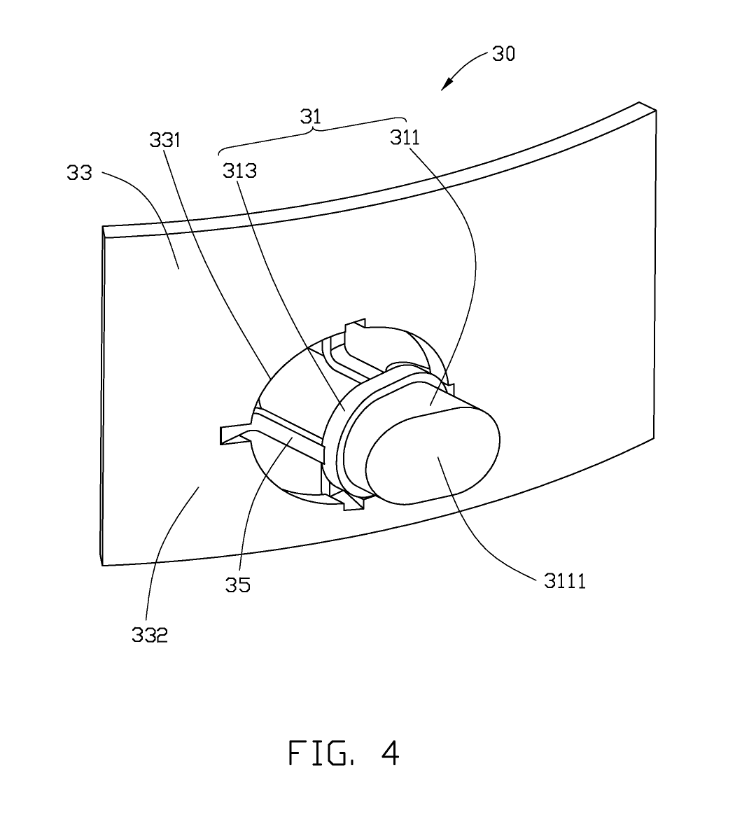

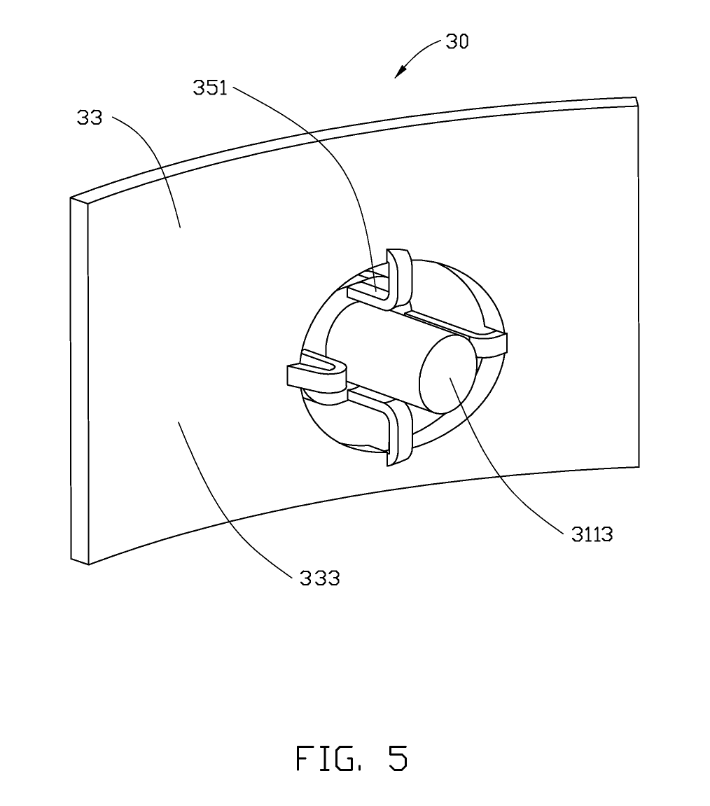

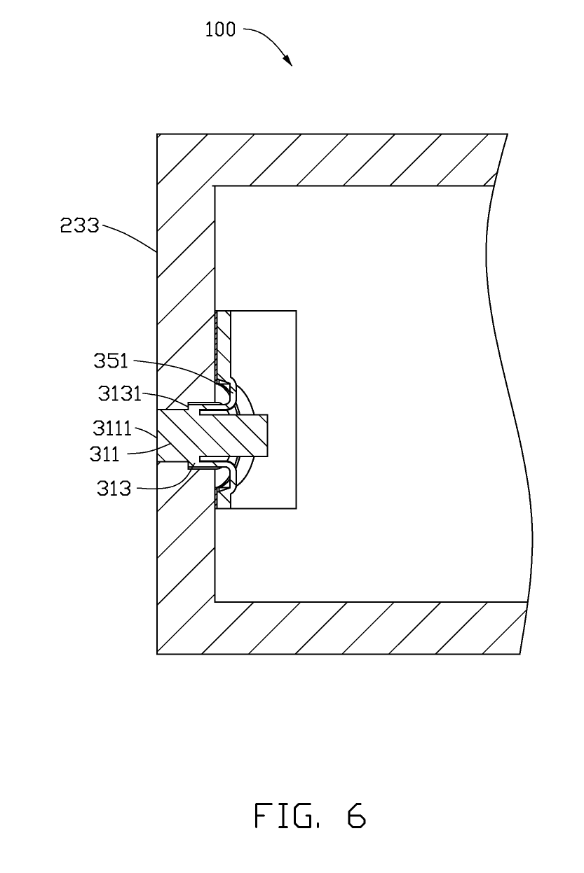

Referring to FIG. 4 through 6, the light guiding pipe 30 includes a light guiding portion 31, a fixing portion 33, and a connecting portion 35 interconnecting the light guiding portion 31 and the fixing portion 33. In the illustrated embodiment, the light guiding portion 31 can be a substantially cylinder and is received in the fixing hole 235 of the side wall 23. The light guiding portion 31 includes a main body 311 and a flange 313 formed on the outer surface of the middle portion of the main body 311. The main body 311 includes an outer end surface 3111 and an inner end surface 3113 (see FIG. 5) opposite to the outer end surface 3111. An end of the flange 313 adjacent to the end surface 3111 forms an assembly surface 3131 (see FIG. 6) corresponding to the fixing surface 2351. The distance between the assembly surface 3131 and the outer end surface 3111 is the same as that of between the fixing surface 2351 and the outer surface 233.

The fixing portion 33 can be substantially square shaped. The fixing portion 33 includes a through hole 331 defined in the fixing portion 33, an adhering surface 332, and a top surface 333 opposite to the adhering surface 332. The fixing portion 33 is placed around the light guiding portion 31 with the light guiding portion 31 extending through the through hole 331. The connecting portion 35 is elastic. In the illustrated embodiment, the connecting portion 35 includes a plurality of elastic arms 351. An end of the elastic arm 351 extends from an end of the flange 313 away from the assembly surface 3131, and the other end of the elastic arm 351 connects with an edge of the inner wall of the through hole 331. In the illustrated embodiment, the number of the elastic arms 351 is four, the light guiding pipe 30 is made of polymethylmethacrylate (PMMA), and is integrally formed with the elastic arms 351. In an alternative embodiment, the number of the elastic arms 351 can be two or more.

In an alternative embodiment, the light guiding pipe 30 includes a light guiding portion 31 and a fixing portion 33 placed around the light guiding portion 31. The light guiding portion 31 extends transversely from the middle portion of the fixing portion 33 towards two opposite sides of the fixing portion 33.

The adhering member 50 is used to adhere the light guiding pipe 30 to the housing 20. In the illustrated embodiment, the adhering member 50 is a double-sided adhesive. The adhering member 50 can be a substantially square shaped corresponding to the fixing portion 33. The adhering member 50 defines an inserting hole 501 at about the middle region corresponding to the through hole 331 of the fixing portion 33. The thickness of the adhering member 50 plus the distance between the fixing surface 2351 and the inner surface 231 is slightly shorter than the distance between the adhering surface 332 and the assembly surface 3131. In an alternative embodiment, an adhesive can form the adhering member 50.

In assembly, the adhering member 50 is adhered to the inner surface 231 of the side wall 23, with the inserting hole 501 corresponding to the fixing hole 235. An end of the light guiding pipe 30 adjacent to the assembly surface 3131 is inserted in the fixing hole 235, with the assembly surface 3131 resisting against the fixing surface 2351. The fixing portion 33 is adhered to the side wall 23 of the housing 20, and the light guiding pipe 30 is assembled to the housing 20.

In summary, because the fixing surface 2351 is small in area and the outer surface 233 can be a reference surface to machine the fixing surface 2351, it is easier to control the machining precision of the fixing surface 2351 than that of the inner surface 231. At the same time, the thickness of the adhering member 50 plus the distance between fixing surface 2351 and the inner surface 231 is slightly shorter than the distance between the adhering surface 332 and the assembly surface 3131. When the fixing portion 33 is adhered to the inner surface 231, the fixing portion 33 of the light guiding pipe 30 is received and assembled in the fixing hole 235, and the connecting portions 35 can adjust the position of the light guiding pipe 30 due to the deformation of the connecting portions 35. It makes sure that the assembly surface 3131 continuously resists against the fixing surface 2351. The fixing surface 2351 prevents the fixing portion 33 from moving towards the outer surface 233 of the housing 20, and the light guiding pipe 30 is firmly fixed in the fixing hole 235. As a result, both the outer appearances of the electronic device 100 and the installation precision of the light guiding pipe 30 are improved.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An electronic device, comprising:
a housing comprising a side wall, the side wall defining a stepped fixing hole, the stepped fixing hole comprising a fixing surface towards the inside of the housing;
an adhering member; and
a light guiding pipe comprising a light guiding portion, the light guiding portion comprising a main body and a flange formed at the outer side of the main body, wherein the flange comprises an assembly surface corresponding to the fixing surface, the light guiding pipe is adhered to the housing by the adhering member, with the light guiding pipe inserting in the stepped fixing hole and the assembly surface resisting against the fixing surface.

2. The electronic device of claim 1, wherein the light guiding pipe further comprises a fixing portion positioned around the light guiding portion, and connected with the light guiding portion.

3. The electronic device of claim 2, wherein the fixing portion comprises a through hole defined in the middle portion thereof and an adhering surface adjacent to the side wall of the housing, the fixing portion is placed around the light guiding portion with the light guiding portion extending through the through hole, and the light guiding pipe further comprises a connecting portion interconnecting the light guiding portion and the fixing portion, and the connecting portion is elastic.

4. The electronic device of claim 3, wherein the connecting portion comprises a plurality of elastic arms, an end of each elastic arm extends from an end of the flange away from the assembly surface, and the other end of each elastic arm connects with an edge of the inner wall of the through hole.

5. The electronic device of claim 1, wherein the main body comprises an outer end surface and an inner end surface opposite to the outer end surface, the assembly surface is formed adjacent to the outer end surface.

6. The electronic device of claim 5, wherein the side wall comprises an inner surface and an outer surface opposite to the inner surface, the light guiding pipe is adhered to the inner surface.

7. The electronic device of claim 6, wherein the distance between the assembly surface and the outer end surface of the main body is the same as the distance between the fixing surface and the outer surface of the side wall.

8. The electronic device of claim 6, wherein the thickness of the adhering member plus the distance between the fixing surface and the inner surface is shorter than the distance between the adhering surface and the assembly surface.

9. The electronic device of claim 1, wherein the adhering member is a double-sided adhesive defining an inserting hole at about the center of the adhering member corresponding to the through hole.

10. An electronic device, comprising:
a housing defining a stepped fixing hole, the stepped fixing hole comprising a fixing surface towards the inside of the housing;
an adhering member; and
a light guiding pipe comprising a light guiding portion and a fixing portion connected with the light guiding portion, the light guiding portion comprising a main body and a flange formed at the outer side of the main body, the flange comprising an assembly surface facing the fixing surface, wherein the light guiding portion is inserted in the stepped fixing hole and the assembly surface resisting against the fixing surface, and the fixing portion is connected to the main body in the housing and adhered to the housing via the adhering member.

11. The electronic device of claim 10, wherein the fixing portion comprises a through hole defined in the middle portion thereof, the fixing portion is placed around the light guiding portion with the light guiding portion extending through the through hole, and the light guiding pipe further comprises a connecting portion interconnecting the light guiding portion and the fixing portion, and the connecting portion is elastic.

12. The electronic device of claim 11, wherein the connecting portion comprises a plurality of elastic arms, an end of each elastic arm extends from an end of the flange away from the assembly surface, and the other end of each elastic arm connects with an edge of the inner wall of the through hole.

13. The electronic device of claim 12, wherein the main body comprises an outer end surface and an inner end surface opposite to the outer end surface, and the assembly surface is formed at an end of the flange adjacent to the outer end surface.

14. The electronic device of claim 13, wherein the housing comprises a side wall, the stepped fixing hole defined in the side wall, the side wall comprises an inner surface and an outer surface opposite to the inner surface, the light guiding pipe is adhered to the inner surface.

15. The electronic device of claim 14, wherein the distance between the assembly surface and the outer end surface of the main body is the same as the distance between the fixing surface and the outer surface of the side wall.

16. The electronic device of claim 14, wherein the thickness of the adhering member plus the distance between the fixing surface and the inner surface is shorter than the distance between the adhering surface and the assembly surface.

17. The electronic device of claim 11, wherein the adhering member is a double-sided adhesive defining an inserting hole at about the center of the adhering member corresponding to the through hole.
